(19) United States
(12) Patent Application Publication
(10) Pub. No.: US 2013/0339838 A1
(43) Pub. Date: Dec. 19, 2013

(54) METHODS FOR COLUMN DELETION IN SHAREPOINT

(71) Applicant: Arun Kumar Venkata Swamy Ananda, Kolar (IN)

(72) Inventor: Arun Kumar Venkata Swamy Ananda, Kolar (IN)

(21) Appl. No.: 13/564,869

(22) Filed: Aug. 2, 2012

(30) Foreign Application Priority Data
Jun. 13, 2012 (IN) 1825/DEL/2012

(51) Int. Cl. G06F 17/24

(52) U.S. Cl. CPC G06F 17/245
USPC 715/227

(57) ABSTRACT

A computer-implemented method, comprises presenting a graphical user interface displaying a plurality of column identifiers, each column identifier associated with a column in one or more of (i) lists and libraries and (ii) site collection fields, the graphical user interface further accepting user input to select one or more of the column identifiers; receiving user input selecting one or more of the column identifiers; and deleting one or more columns corresponding to the one or more selected column identifiers.

### FIELD OF THE INVENTION

This application relates to methods for viewing, analyzing and/or deleting one or more columns in a Microsoft® SharePoint® site column and/or a Microsoft SharePoint library created by content types.

### BACKGROUND

In a project life cycle, a business might produce several different kinds of content, such as proposals, financial tracking, work flows and product design specifications. Although documents having such content might be stored together because they are related to a single project, these documents might be created, used, shared, and retained in different ways. Further, a business may want to collect and maintain different kinds of metadata regarding each type of content.

In Microsoft® SharePoint®, a content type is a reusable collection or settings of metadata (metadata called columns in SharePoint), workflow, behaviour, and other settings for a category of items or documents in a Microsoft SharePoint list or document library. A content type describes a shared behaviour for a specific type of content. Content type is a data schema for information that is stored in a SharePoint document library. The items or the documents are created using the content type; hence items or documents that are created from the content type conform to their respective data schema.

When a content type is activated in a Microsoft SharePoint list or document library, columns are created in the document library and SharePoint site columns. SharePoint allows end users to delete columns from SharePoint site columns. For example, users can use a cursor control device to select a column presented as a hyperlink and select a checkbox associated with that column to delete that column. However, SharePoint does not provide an option to delete the columns created by the content type or allow users to delete columns from the document library. The columns added in the library by the content type are typically greyed out.

The inability to delete columns is also encountered when columns are renamed. In this instance, the originally named columns (i.e., “orphaned columns) will still remain in the library and SharePoint does not offer any convenient user interface to delete these orphaned columns. One approach to addressing such deficiency is to move all files within one SharePoint library to a new SharePoint library. Doing this, however, will lose the metadata of the previous versions (e.g., the modified date, person who performed the modification, etc.) of the items or documents. Losing the metadata of the previous versions may not be acceptable in some instances.

### SUMMARY

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

In one embodiment, a graphical user interface is provided for a user to view, analyze and/or delete one or more columns created in SharePoint.

In another embodiment, a computer-implemented method, comprises presenting a graphical user interface displaying a plurality of column identifiers, each column identifier associated with a column in one or more of (i) lists and libraries and (ii) site collection fields, the graphical user interface further accepting user input to select one or more of the column identifiers; receiving user input selecting one or more of the column identifiers; and deleting one or more columns corresponding to the one or more selected column identifiers.

In yet another embodiment, a non-transitory machine-readable storage medium, comprises first software instructions that, when executed by a processor, cause the processor to present a graphical user interface displaying a plurality of column identifiers, each column identifier associated with a column in one or more of (i) lists and libraries and (ii) site collection fields, the graphical user interface further accepting user input to select one or more of the column identifiers; second software instructions that, when executed by the processor, cause the processor to receive user input selecting one or more of the column identifiers; and third software instructions that, when executed by the processor, cause the processor to delete one or more columns corresponding to the one or more selected column identifiers.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a flowchart that provides a general overview of a process to view, analyze and/or delete one or more columns, according to an exemplary embodiment.

FIG. 2 depicts a graphical user interface for a user to input certain input fields and/or to select an execution type, according to an exemplary embodiment.

FIGS. 3-5 depict a graphical user interface for a user to select a type of column analysis, according to an exemplary embodiment.

FIG. 6 depicts a graphical user interface, in which a listing of files containing reports of the content analysis are presented, according to an exemplary embodiment.

FIGS. 7-8 depict a graphical user interface for a user to select a type of column deletion, according to an exemplary embodiment.

FIG. 9 depicts a graphical user interface, in which a listing of files containing reports of column analysis and column deletion are presented, according to an exemplary embodiment.

FIG. 10 depicts a screenshot of a report of deleted columns, according to an exemplary embodiment.

FIG. 11 depicts a graphical user interface, in which columns marked for deletion are displayed, according to an exemplary embodiment.

FIG. 12 depicts a graphical user interface, which shows the remaining columns after a deletion operation, according to an exemplary embodiment.

FIG. 13 depicts a computing system, according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Microsoft SharePoint is built on .Net and hence has a rich object model. Microsoft introduces necessary and/or required features in the initial release of its products and improves on or introduces new features to its products based on monitored usage and/or feedback received from users. There is, however, no convenient graphical user interface in SharePoint to delete the columns created in the document library.

In one embodiment, a software routine provides users with the ability to generate a report (also called a “log”) of columns in the content types, libraries and lists, and site collection fields before the deletion of columns. Upon reviewing the report, a user can select which columns (specifically columns from a SharePoint library created by content type) to delete. In the software routine, files need not be transferred to new libraries, allowing records of file versions to be preserved. Upon deletion of the selected columns, the software routine can generate a detailed report of the columns that have been deleted and/or those that remain.

In one embodiment, the software routine is designed to operate with Windows® SharePoint Services 3.0. Software requirements for the graphical user interface may include one or more of Visual Studio Enterprise edition 2008, the .Net framework 3.5 and the SharePoint Object model. Further, the software routine may need to be copied to one of the servers in the farm and may be limited to only accessing its own farm and without the ability to access a remote farm.

In one embodiment, columns created in a list, a library, or a site column may be deleted using a SharePoint Object Model class. For example, the SPFieldCollection Class located in the SharePoint Object Model may be used. By default, columns created by the content type are always set to read-only. In one embodiment, to allow for the deletion of columns, the software routine loops through each content type, identifies a column to be deleted, and sets the read-only property of that column to false. Any changes made (in the present case, setting a read-only property false) to an object (i.e., the underlying representation of a column) typically requires an “update” method associated with the object to be called. Objects typically also have a “delete” method, which when called, deletes a column. Upon deletion of the desired columns, the software routine updates the Microsoft SharePoint list.

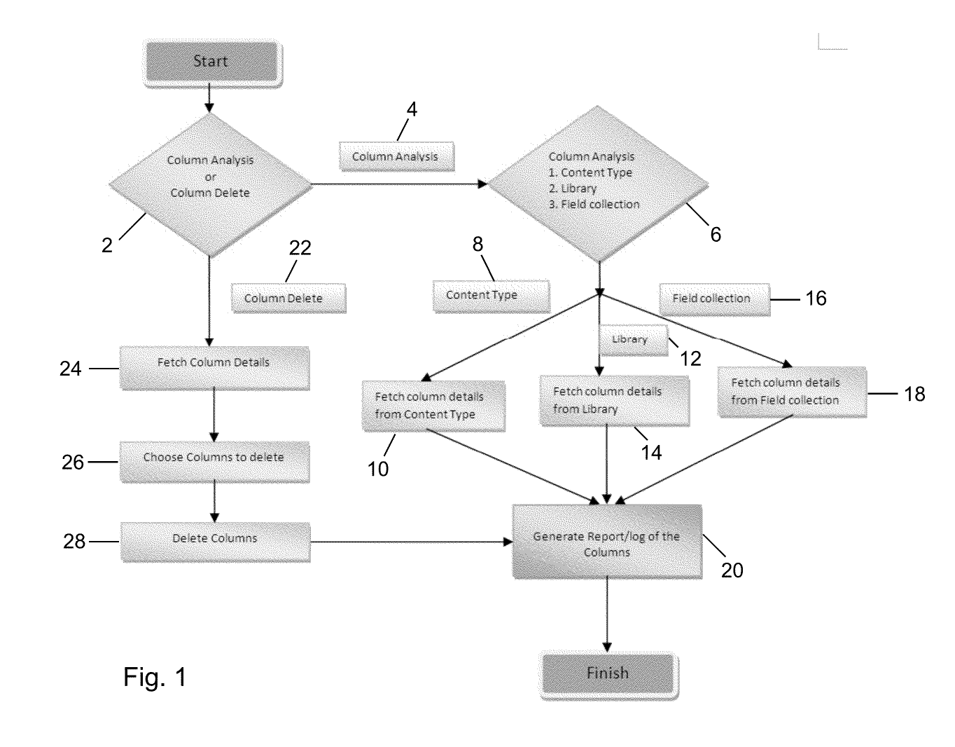

FIG. 1 depicts a flowchart that provides a general overview of a process to view, analyze and/or delete one or more columns. First, a user may be prompted to select whether he/she desires to analyze a column or delete a column (step 2). If the user provides input indicating that he/she desires to analyze a column (step 4), the user may be prompted to select whether he/she desires to view column information in the content types, lists/libraries, or site field collections (step 6). If the user provides input indicating that he/she desires to view column information in the content types (step 8), column information is retrieved from the content types (step 10). If the user provides input indicating that he/she desires to view column information in the lists/libraries (step 12), column information is retrieved from the lists/libraries (step 14). If the user provides input indicating that he/she desires to view column information in the site field collections (step 16), column information is retrieved from the site field collections (step 18). Following such retrieval of column information, a report/log of the column(s) may be generated (step 20).

If the user provides input indicating that he/she desires to delete a column (step 22), the software routine retrieves column information (step 24). Next, the user may be prompted to select which column(s) he/she desires to delete (step 26). Upon receipt of information identifying the column(s) to be deleted, the software routine deletes the selected column(s) (step 28). Following deletion of the column(s), a report/log of the remaining columns and/or deleted columns may be generated (step 20).

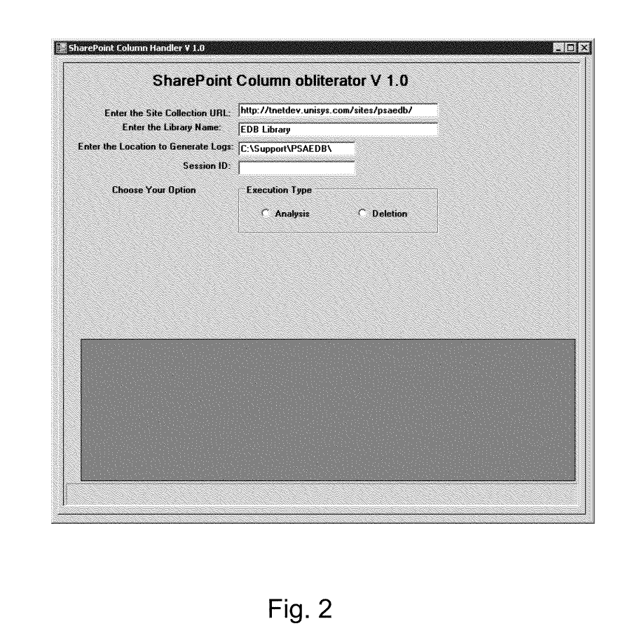

The flowchart depicted in FIG. 1 will now be described in more detail by referencing the screenshots depicted in FIGS. 2-11. Prior to being prompted for his/her selection for either analyzing or deleting a column, a user may first be prompted to input certain fields, as depicted in the screenshot of the exemplary graphical user interface provided in FIG. 2. The fields may include a site collection uniform resource locator (URL), a library name, a location (e.g., folder name and/or directory) where generated reports are output and stored, and a session identifier (ID). In the example provided in FIG. 2, the user has input the site collection URL of http://tnetdev.unisys.com/sites/psaedb/, the library name of EDB Library, and the location of C:\Support\PSAEDB\, while the session ID has been left blank (as mentioned below, the session ID is an optional field). The site collection URL is an input utilized by the software routine to recognize which site collection should be run. The library name is an input utilized by the software routine to identify the particular library for which column analysis and/or deletion should be performed. The session ID is an optional input for the user to identify the session he/she is executing. The session ID is subsequently appended in the file name of the report created by the software routine.

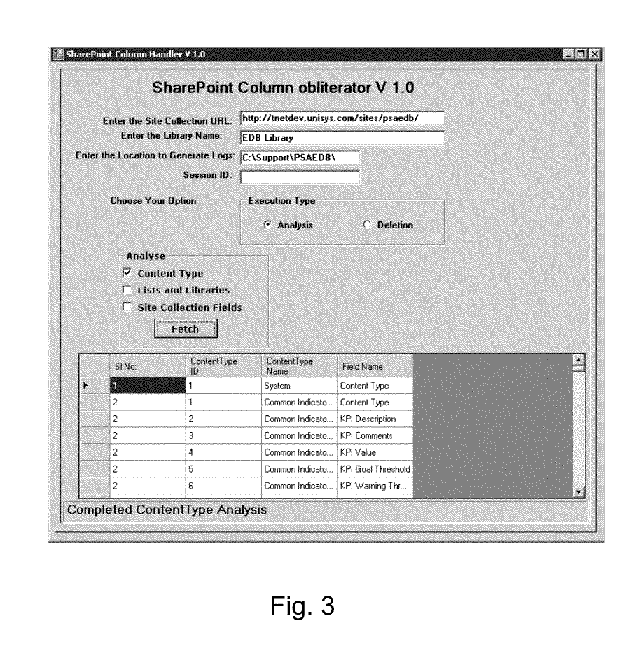

The user may also be prompted to select an execution type to indicate whether he/she desires to analyze or delete a column, as depicted in FIG. 2. If the selection of “Analysis” is received, as depicted in FIG. 3, the user may be prompted to input the type of column analysis he/she desires. FIG. 3 further depicts three checkboxes allowing the user to select whether the analysis should be performed for columns in the content types, lists and libraries, or site collection fields. Another selection mechanism besides checkboxes, such as radial buttons, and the like may be used instead.

If the user selects the checkbox associated with “Content Type” followed by selecting the “Fetch” button, a report regarding the columns in the content types is generated. An example report of the columns in the content types is depicted in the bottom portion of FIG. 3. The example report displays the serial number (SI No.), ContentType identifier (ID), ContentType Name and Field Name associated with each column. In a site collection, there can be more than one content type. Hence, the need may arise to retrieve the columns associated with each content type.

More specifically, the content type analysis report contains the different content types available in the site collection and its associated columns. “SI no” represents the content type number and is a logical numbering assigned to each content type. “Content type ID” is a logical numbering assigned to the columns of a particular content type. “ContentType Name” is a name assigned to a content type for recognizing the content type. “Field Name” is the column name created by a content type. For example, the columns “Content Type,” “KPI Description,” “KPI Comments,” “KPI Value,” “KPI Goal Threshold” and “KPI Warning Thr . . . ” all share the SI no of 2, because they are created by the common content type of “Common Indicato . . . ”

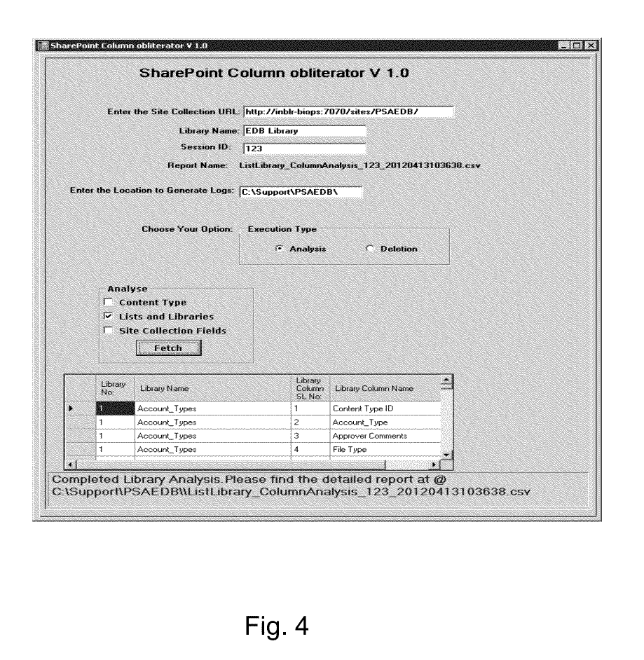

If the user selects the checkbox associated with “Lists and Libraries” followed by selecting the “Fetch” button, a report regarding the columns in the lists and libraries is generated. An example report of the columns in the lists and libraries is depicted in the bottom portion of FIG. 4. The lists and libraries analysis report contains the different lists and libraries available in the site collection and its associated columns. “Library no” represents the library number, and is a logical numbering assigned to a library. The “Library Name” is a name assigned to a library. The “Library Column SL No” represents the library column number, and is a logical numbering assigned to a library column. The “Library Column Name” is the name of a column that exists in a library. Multiple library columns may share a common library number to indicate that these library columns all exists within the same library.

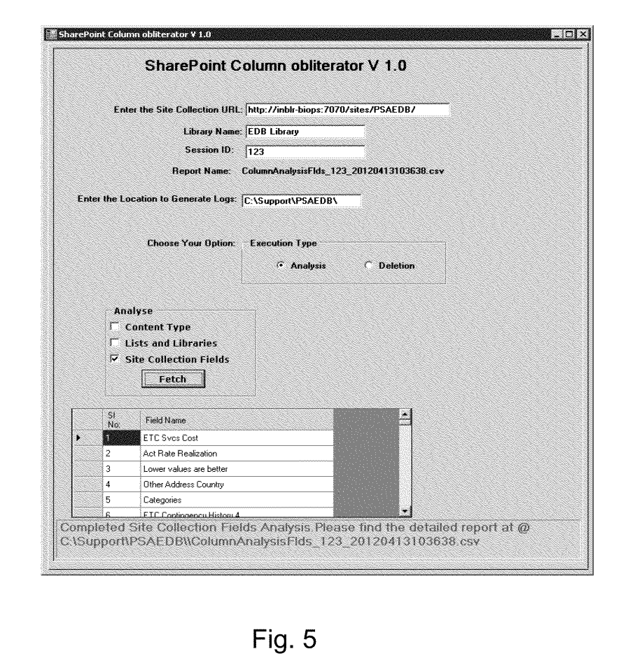

If the user selects the checkbox associated with “Site Collection Fields” followed by selecting the “Fetch” button, a report regarding the columns in the site collection fields is generated. An example report of the columns in the site collection fields is depicted in the bottom portion of FIG. 5. The site collection fields analysis report contains all the fields that are available for the site collection. “SI no” represents the Field number, and is a logical numbering assigned to each field. “Field Name” is the name of individual columns that exist in the site collection.

In one embodiment, a status bar may be used to display the status of various operations. For example, in FIG. 3, a message “Completed ContentType Analysis” may be displayed in the status bar to indicate that the report of the columns in the content types has been completed. For example, in FIG. 4, a message “Completed Library Analysis. Please find the detailed report at @ c:\Support\PSAEDB\\ListLibrary_ColumnAnalysis_{—}123_{—}20120413103638.csv” may be displayed in the status bar to indicate that the report of the columns in the lists and libraries has been completed, and that a detailed report may be found at a certain directory with a certain file name.

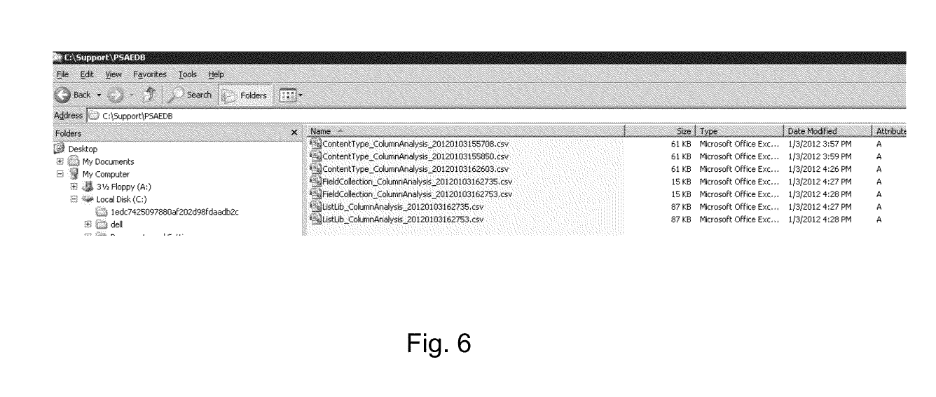

In addition or alternatively to the column analysis reports depicted in FIGS. 3-5, reports may also be automatically saved to a user-specified (or default) directory. As depicted in the screenshot of FIG. 6, reports have been automatically saved to the user-specified directory of C:\Support\PSAEDB\, corresponding to the directory input by the user in the screenshot of FIG. 2. A certain naming convention may be used for these reports so that multiple reports are never assigned the same file name. For example, the file name for a content types report may be ContentType_ColumnAnalysis_Session_ID_YYYYMMDDHHMMSS.csv, where Session_ID, YYYY, MM, DD, HH, MM and SS are placeholders for the session ID, year, month, day, hour, minute and second associated with the report, respectively. Likewise, the file name for a lists and libraries report may be ListLibrary_ColumnAnalysis_Session_ID_YYYYMMDDHHMMSS.csv, and the file name for a site collection fields report may be FieldCollection_ColumnAnalysis_Session_ID_YYYYMMDDHHMMSS.csv. As mentioned above, the “Session ID” is an optional field. Accordingly, it is included in the report name only if such field is provided by the user. The presentation of these reports is substantially identical to the reports depicted in FIGS. 3-5, and therefore exemplary reports corresponding to these files have been omitted for brevity. Such file naming conventions are exemplary and other naming conventions are possible.

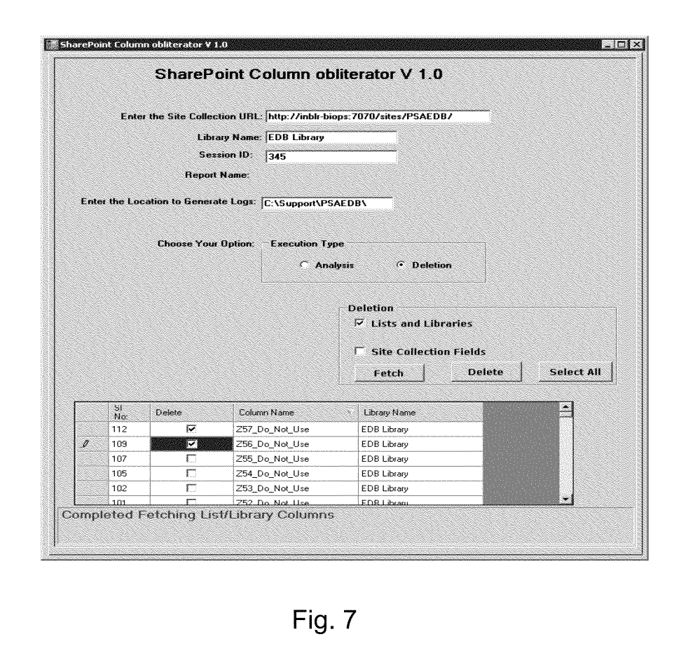

If the selection of deleting one or more columns is received (e.g., selection of the “Deletion” button associated with the Execution Type), the user may be prompted to select whether he/she desires to delete a column in the lists and libraries or site collection fields. FIG. 7 depicts a screenshot of an exemplary graphical user interface, in which checkboxes (other selection mechanisms are possible) are provided for a user to select between lists and libraries or site collection fields.

If the user selects the checkbox associated with “Lists and Libraries” followed by selecting the “Fetch” button, a report regarding the columns in the lists and libraries is generated, as depicted in the bottom portion of FIG. 7. In contrast to reports generated using the analysis option, reports generated using the deletion option have checkboxes (other selection mechanisms are possible) which allow the user to select individual columns for deletion. In the report depicted in FIG. 7, columns are identified by both a serial number (i.e., abbreviation of “SI No:” used in FIG. 7) and a column name. Such presentation is merely exemplary, and columns may be identified by more or fewer column identifiers. Following the selection of one or more columns to delete, the user may select the “Delete” button to delete the selected columns.

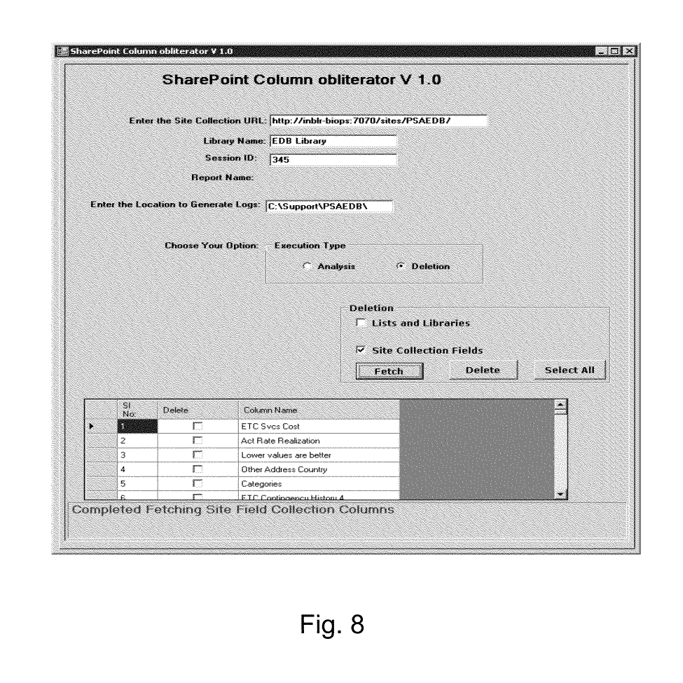

If the user selects the checkbox associated with “Site Collection Fields” followed by selecting the “Fetch” button, a report regarding the columns in the site collection fields is generated, as depicted in FIG. 8. All the fields available in the site collection are displayed in the report.

It is further noted in FIGS. 7 and 8, a “Select All” button is provided for a user to select all columns in the report for deletion (i.e., all checkboxes will be checked). Upon selecting the “Select All” button and selecting the “Delete” button, all columns in the report will be deleted.

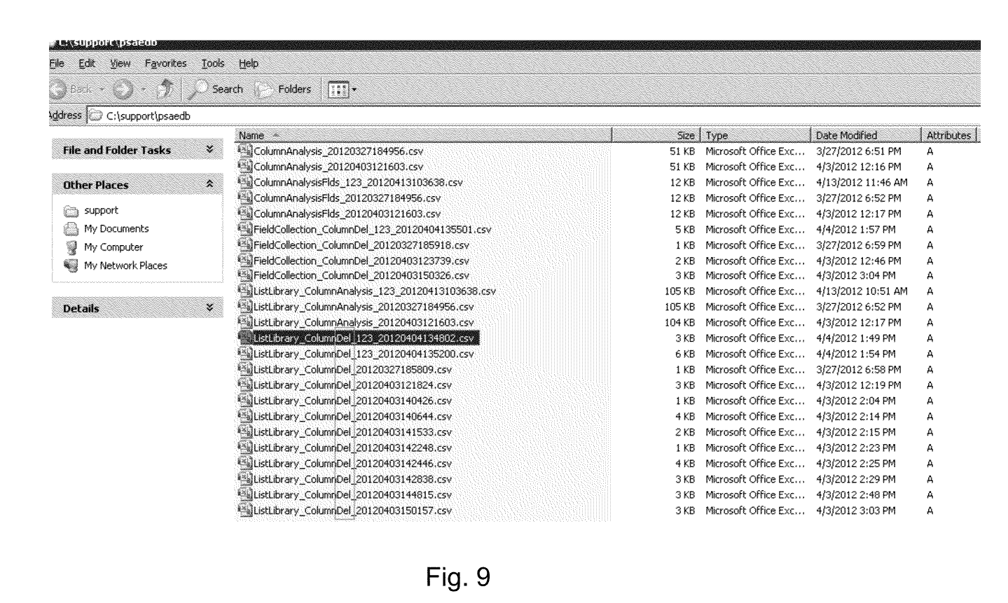

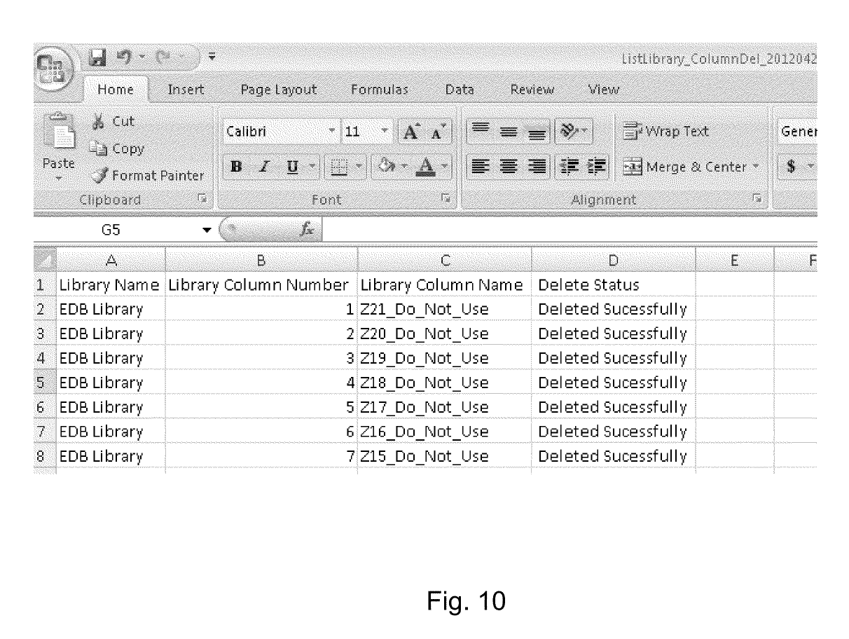

A report of the deleted columns may be automatically generated with the file naming convention of ListLibrary_ColumnDel_YYYYMMDDHHMMSS_D.csv. Such file naming convention is exemplary and other naming conventions are possible. A listing of such reports is depicted in FIG. 9. An example report of deleted columns is depicted in FIG. 10. This report contains the following details: SL #, Library Column SL Number, Library Name, Library Column Name and Delete Status. The “Delete Status” is updated to “deleted successfully” upon successful deletion of a corresponding column.

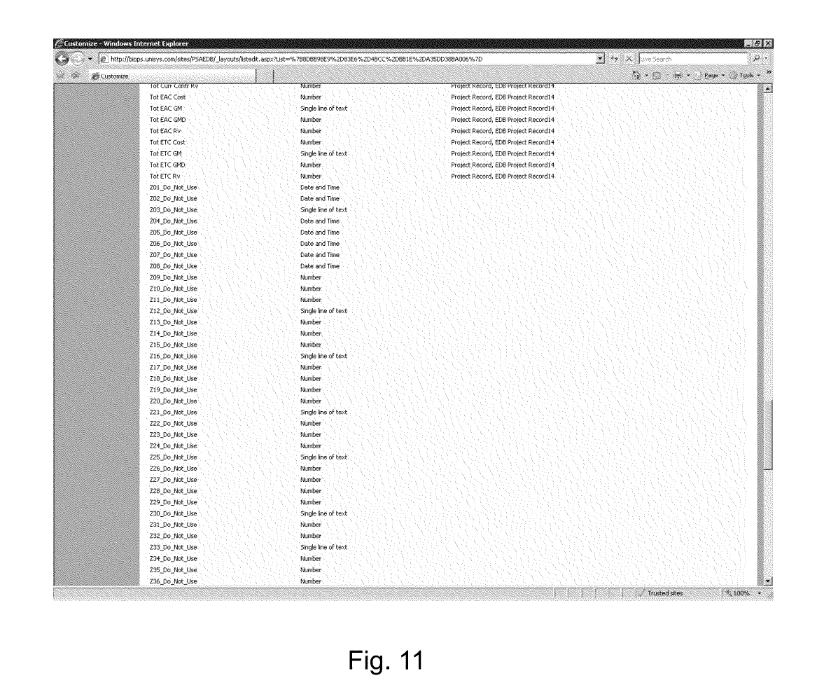

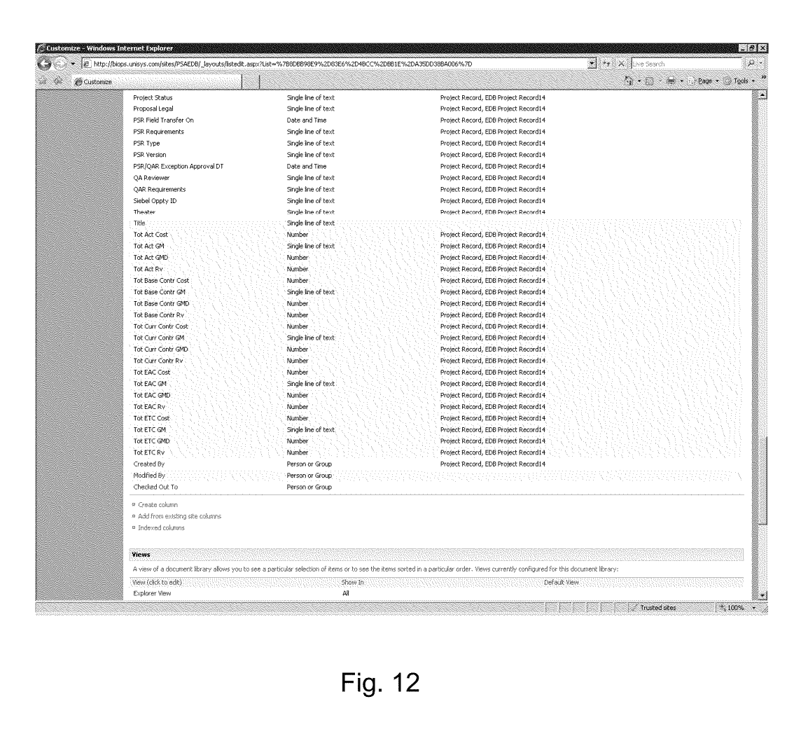

FIGS. 11 and 12 are screenshots of a library before and after a column deletion operation. In FIG. 11, there are a number of columns named “ZXX_Do_Not_Use” that have been marked for deletion, in which XX represents a logical numbering of columns marked for deletion. In FIG. 12, all columns with the Do_Not_Use identifier have been deleted. It is noted that, in general, the user has the option of deleting certain ones of the Do_Not_Use columns.

In implementing these systems and methods to be performed by a suitably programmed computer, it is intended that the computer has a processor and a computer readable medium, wherein the computer readable medium has program code. The program code can be made of one or more modules that carry out instructions for implementing the systems and methods herein. The processor can execute the instructions as programmed in the modules of the program code. For example, the processor can execute instructions for determining, calculating, assigning, obtaining, converting, computing, and variations thereof.

The systems and methods described can be implemented as a computer program product having a tangible computer readable medium having a computer readable program code embodied therein, the computer readable program code adapted to be executed to implement a method for performing the methods described above. Each step or aspect can be performed by a different module, or a single module can perform more than a single step.

The systems and methods described herein as software can be executed on at least one server, though it is understood that they can be configured in other ways and retain its functionality. The above-described technology can be implemented on known devices such as a personal computer, a special purpose computer, cellular telephone, personal digital assistant (PDA), a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

Moreover, the disclosed methods may be readily implemented in software, e.g., as a computer program product having one or more modules each adapted for one or more functions of the software, executed on a programmed general purpose computer, cellular telephone, PDA, a special purpose computer, a microprocessor, or the like. In these instances, the systems and methods of this invention can be implemented as a program embedded on a personal computer such as a JAVA®, CGI or Perl script, as a resource residing on a server or graphics workstation, as a routine embedded in a dedicated image system, or the like. The systems and methods of this invention can also be implemented by physically incorporating this system and method into a software and/or hardware system, such as the hardware and software systems of a computer. Such computer program products and systems can be distributed and employ a client-server architecture.

### Block Diagram of Computer System

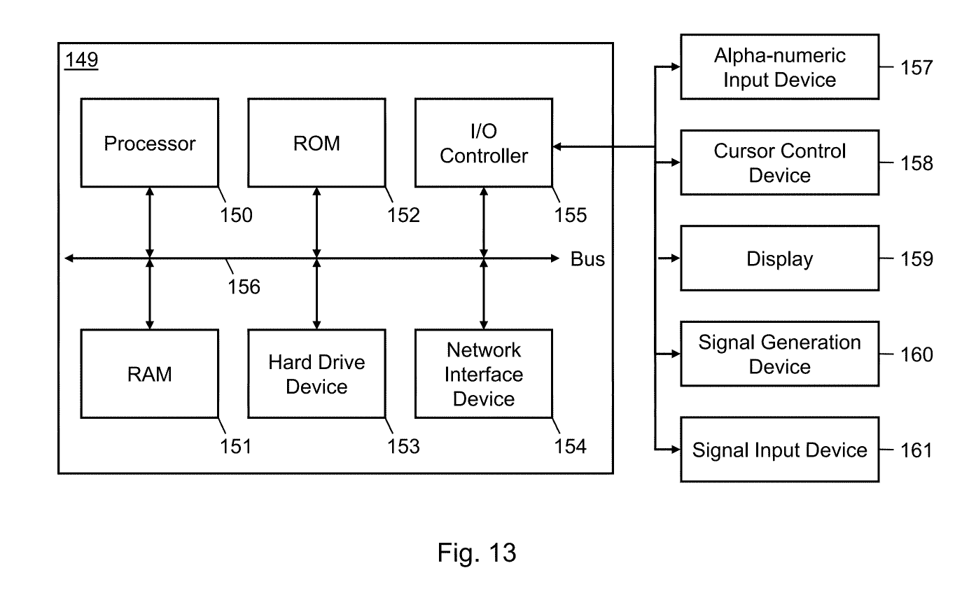

FIG. 13 of the accompanying drawings illustrates computer system 149, also known as a data processing system. The operations, processes, modules, methods, and systems described and shown in the accompanying figures of this disclosure are intended to operate on one or more computer systems as sets of instructions (e.g., software), also known as computer-implemented methods. The computer system depicted in FIG. 13 is generally representative of any client computing device, server computing device and/or mobile device (e.g., a mobile cellular device, Personal Digital Assistant (PDA), satellite phone, mobile Voice over Internet Protocol (VoIP) device, iPhone®, iPad®). Computer system 149 includes at least one processor 150 (e.g., a Central Processing Unit (CPU), a Graphics Processing Unit (GPU) or both), Random Access Memory (RAM) 151 (e.g., flash memory, Dynamic Random Access Memory (DRAM), Static Random Access Memory (SRAM), Synchronous DRAM (SDRAM), etc.), Read Only Memory (ROM) 152 (e.g., Erasable Programmable Read Only Memory (EPROM), Electrically Erasable Programmable Read Only Memory (EEPROM)), hard drive device 153 whether built-in, internal, external and/or removable (e.g., USB device, magnetic storage device, optical storage device, compact disk (CD) read/write device, digital video disk (DVD) read/write device, floppy disk read/write device, etc.), a network interface device 154, and input/output (I/O) controller 155, which are communicatively coupled with one another other via one or more busses 156.

I/O controller 155 may interface computer system 149 with alpha-numeric input device 157 (e.g., a keyboard, phone pad, touch screen), cursor control device 158 (e.g., a mouse, joy-stick, touch-pad), display 159 (e.g., Liquid Crystal Display (LCD), a Cathode Ray Tube (CRT) or a touch screen), signal generation device 160 (e.g., a speaker, ear buds, a headset), and signal input device 161 (e.g., a microphone, camera, fingerprint scanner, web-cam).

Network interface device 154 may include, for example, a network interface card (NIC), Ethernet card, and/or dial-up modem, and may be communicatively coupled to a network (not depicted). In addition, the network interface device may be a wireless network interface device in the case of mobile device communicatively coupled to a network (e.g., a cellular, VoIP and/or WiFi network). If computer system 149 is server, alpha-numeric input device 157, cursor control device 158, display 159, signal generation device 160 and/or signal input device 161 may be omitted.

One or more of ROM 152, RAM 151, and hard drive device 153 includes a computer-readable storage medium on which is stored one or more sets of computer-readable instructions (e.g. software) embodying one or more of the operations described herein. The computer-readable storage medium may include a single medium or multiple media (e.g., a centralized or distributed database, and/or associated caches and servers) that store the one or more sets of computer-readable instructions. The term “computer-readable storage medium” shall also be taken to include any physical/tangible medium that is capable of storing or encoding a set of instructions for execution by a processor.

The embodiments described above are intended to be exemplary. One skilled in the art recognizes that numerous alternative components and embodiments that may be substituted for the particular examples described herein and still fall within the scope of the invention.

What is claimed is:

1. A computer-implemented method, comprising:
presenting, using a computer, a graphical user interface displaying a plurality of column identifiers, each column identifier associated with a column in one or more of (i) lists and libraries and (ii) site collection fields, the graphical user interface further accepting user input to select one or more of the column identifiers;
receiving, using a computer, user input selecting one or more of the column identifiers; and
deleting, using a computer, one or more columns corresponding to the one or more selected column identifiers.

2. The computer-implemented method of claim 1, wherein the column identifiers comprise one or more of serial numbers and column names.

3. The computer-implemented method of claim 1, wherein the user input to select one or more of the column identifiers is received via one or more checkboxes and radial buttons.

4. The computer-implemented method of claim 1, further comprising, following the deletion of the one or more columns, generating a report of the one or more columns that have been deleted.

5. The computer-implemented method of claim 4, wherein the report is automatically stored at a user-specified directory.

6. The computer-implemented method of claim 1, further comprising, following the deletion of the one or more columns, generating a report of columns that have not been deleted.

7. The computer-implemented method of claim 1, further comprising, prior to presenting the graphical user interface displaying the plurality of column identifiers, receiving user selection of lists and libraries or site collection fields, and generating the plurality of column identifiers in response to the user selection of lists and libraries or site collection fields.

8. The computer-implemented method of claim 1, wherein the user selection of one or more of the column identifiers corresponds to one or more columns previously marked for deletion.

9. The computer-implemented method of claim 1, wherein deleting the one or more columns comprises setting a read-only property associated with the one or more columns to false.

10. A non-transitory machine-readable storage medium, comprising:
first software instructions that, when executed by a processor, cause the processor to present a graphical user interface displaying a plurality of column identifiers, each column identifier associated with a column in one or more of (i) lists and libraries and (ii) site collection fields, the graphical user interface further accepting user input to select one or more of the column identifiers;
second software instructions that, when executed by the processor, cause the processor to receive user input selecting one or more of the column identifiers; and
third software instructions that, when executed by the processor, cause the processor to delete one or more columns corresponding to the one or more selected column identifiers.

11. The non-transitory machine-readable storage medium of claim 10, wherein the column identifiers comprise one or more of serial numbers and column names.

12. The non-transitory machine-readable storage medium of claim 10, wherein the user input to select one or more of the column identifiers is received via one or more checkboxes and radial buttons.

13. The non-transitory machine-readable storage medium of claim 10, further comprising fourth software instructions that, when executed by the processor, cause the processor to, following the deletion of the one or more columns, generate a report of the one or more columns that have been deleted.

14. The non-transitory machine-readable storage medium of claim 13, wherein the report is automatically stored at a user-specified directory.

15. The non-transitory machine-readable storage medium of claim 10, further comprising fourth software instructions that, when executed by the processor, cause the processor to, following the deletion of the one or more columns, generate a report of columns that have not been deleted.

16. The non-transitory machine-readable storage medium of claim 10, further comprising fourth software instructions that, when executed by the processor, cause the processor to, prior to presenting the graphical user interface displaying the plurality of column identifiers, receive user selection of lists and libraries or site collection fields, and generate the plurality of column identifiers in response to the user selection of lists and libraries or site collection fields.

17. The non-transitory machine-readable storage medium of claim 10, wherein the user selection of one or more of the column identifiers corresponds to one or more columns previously marked for deletion.

18. The non-transitory machine-readable storage medium of claim 10, wherein deleting the one or more columns comprises setting a read-only property associated with the one or more columns to false.
